(19) United States
(12) Patent Application Publication
(10) Pub. No.: US 2025/0113963 A1
(43) Pub. Date: Apr. 10, 2025

(54) METHOD FOR AREA DIVIDING IN MAP FOR MOBILE ROBOT, MOBILE ROBOT AND COMPUTER-READABLE STORAGE MEDIUM

(71) Applicants: Best Epoch Technology Co., LTD, Shenzhen (CN); UBTECH ROBOTICS CORP LTD, Shenzhen (CN)

(72) Inventors: MENG LI, Shenzhen (CN); Xiangbin Huang, Shenzhen (CN)

(21) Appl. No.: 18/888,209

(22) Filed: Sep. 18, 2024

(30) Foreign Application Priority Data
Oct. 8, 2023 (CN) 202311304329.2

(51) Int. Cl. A47L 11/40; G01C 21/32

(52) U.S. Cl. CPC A47L 11/4011; G01C 21/32

(57) ABSTRACT

A method for area dividing in a map for a mobile robot includes: obtaining a target binary map of a target area; obtaining a first area map and a second area map according to the target binary map; obtaining a target area-dividing map of the target area according to the first area map and the second area map; and controlling the mobile robot according to the target area-dividing map.

### CROSS REFERENCE TO RELATED APPLICATIONS

This application claims priority to Chinese Patent Application No. CN 202311304329.2, filed Oct. 8, 2023, which is hereby incorporated by reference herein as if set forth in its entirety.

### TECHNICAL FIELD

The present disclosure generally relates to mobile robots, and in particular relates to a method for area dividing in a map for a mobile robot, mobile robot and computer-readable storage medium.

### BACKGROUND

Mobile robots, including cleaning robots, are becoming increasingly popular among users. They can perform various tasks according to user instructions and offer advantages such as low cost and ease of use. However, due to environmental factors, issues such as inefficient task paths and low operational efficiency arise from the inability to accurately identify the designated work area.

Therefore, there is a need to provide a method for area dividing in a map for a mobile robot to overcome the above-mentioned problems.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a mobile robot according to one embodiment.

FIG. 2 is an exemplary flowchart of a method for area dividing in a map for a mobile robot according to one embodiment.

FIG. 3 is a schematic diagram of an initial binary map according to one embodiment.

FIG. 4 is a schematic diagram of a target binary map according to one embodiment.

FIG. 5 is a schematic diagram of a first area map according to one embodiment.

FIG. 6 is a schematic diagram of a second area map according to one embodiment.

FIG. 7 is an exemplary flowchart of a method for area dividing in a map for a mobile robot according to another embodiment.

FIG. 8 is a schematic block diagram of device for area dividing in a map for a mobile robot according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

The present disclosure provides a method for a mobile robot that processes an initial map generated during a robot mapping process to obtain a target area-dividing map of a target area. In this way, the target area-dividing map of the work areas can be accurately obtained, and the task path can be reasonably planned based on the target area-dividing map, thereby improving operational efficiency of the mobile robot.

The mobile robot can be, but are not limited to, a cleaning robot (e.g., smart vacuum cleaner, smart robot mop, window cleaning robot), a companion mobile robot (e.g., smart electronic pet, nanny robot), a service mobile robot (e.g., reception robot for hotels, motels, and meeting venues), an industrial inspection smart device (e.g., power inspection robot, smart forklift), and a security robot (e.g., household or commercial smart security robot). These examples of robots are provided for illustration purposes only and do not constitute any limitations.

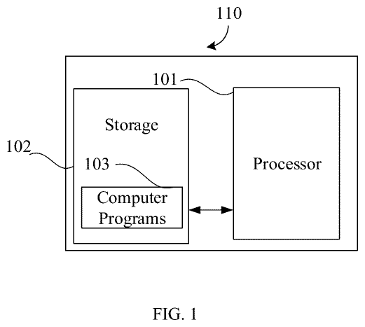

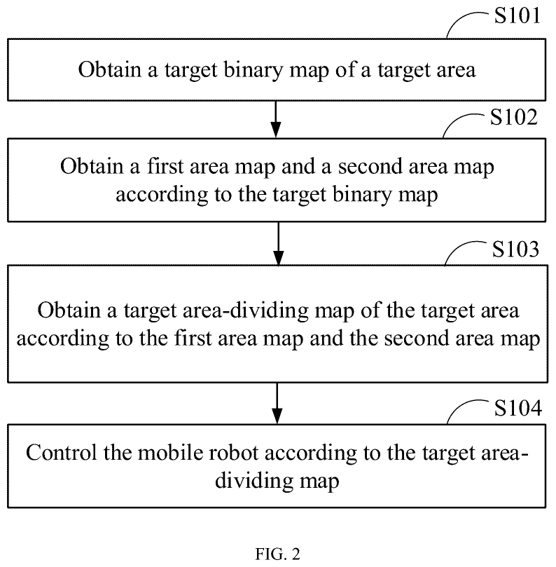

FIG. 1 shows a schematic block diagram of a mobile robot 110 according to one embodiment. The robot 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a method for area dividing in a map for a mobile robot, such as steps S101 to S104 in FIG. 2 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot 110, such as a hard disk or a memory. The storage 102 may also be an external storage device of the robot 110, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the robot 110. The storage 102 can also be used to temporarily store data that have been output or is about to be output.

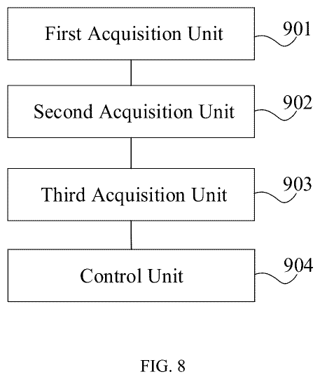

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot 110. For example, the one or more computer programs 103 may be divided into a first acquisition unit 901, a second acquisition unit 902, a third acquisition unit 903, and a control unit 904 as shown in FIG. 8.

It should be noted that the block diagram shown in FIG. 1 is only an example of the robot 110. The robot 110 may include more or fewer components than what is shown in FIG. 1, or have a different configuration than what is shown in FIG. 1. Each component shown in FIG. 1 may be implemented in hardware, software, or a combination thereof.

FIG. 2 is an exemplary flowchart of a method for area dividing in a map for a mobile robot according to one embodiment. As an example, but not a limitation, the method can be implemented by the robot 110. The method may include the following steps.

Step S101: Obtain a target binary map of a target area.

The target binary map includes work areas where the mobile robot can freely move and obstacle areas. The obstacle areas include some unknown areas and areas with obstacles.

In one embodiment, step S101 may include steps S1011 and S1012.

Step S1011: Obtain an initial binary map of the target area.

Step S1012: Preprocess the initial binary map to obtain the target binary map.

In one embodiment, the initial binary map is generated by the mobile robot in a mapping process for the target area. For example, if the mobile robot is a cleaning robot, the initial binary map is generated when the robot maps a house during the initial cleaning. The preprocessing is denoising.

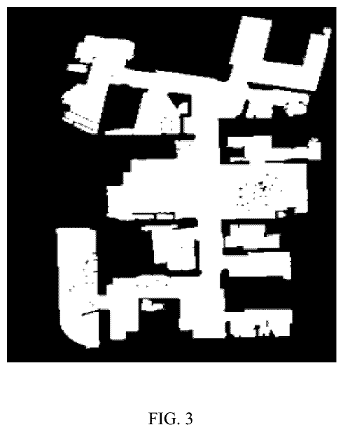

In an example, the initial binary map of the target area is shown in FIG. 3, where the white area is the working area where the mobile robot can freely move, in which there are some scattered obstacle areas composed of obstacles, and the black areas are the obstacle areas.

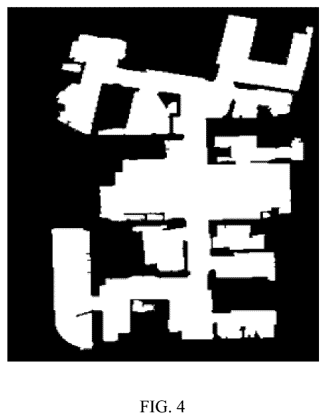

After obtaining the initial binary map of the target area, the initial binary map is denoised to remove the scattered obstacle areas in the working area of the initial binary map, obtaining the target binary map as shown in FIG. 4, which facilitates the subsequent regional extraction on the target binary map.

Step S102: Obtain a first area map and a second area map according to the target binary map.

After the target binary map is obtained, the target binary map can be divided according to the length of each area to obtain a first area map and a second area map.

In one embodiment, step S102 may include the following steps: extracting all of first areas in the target binary map whose lengths are greater than a first preset threshold to obtain the first area map; and extracting all of second areas in the target binary map whose lengths are less than the first preset threshold to obtain the second area map.

The first preset threshold is a positive number, which can be set according to actual needs and is not limited here.

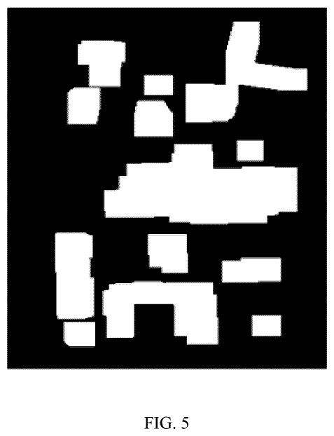

In one embodiment, the first are map (see FIG. 5) can be obtained by dividing the target binary map and extracting all of the first areas whose width or length is greater than the first preset threshold.

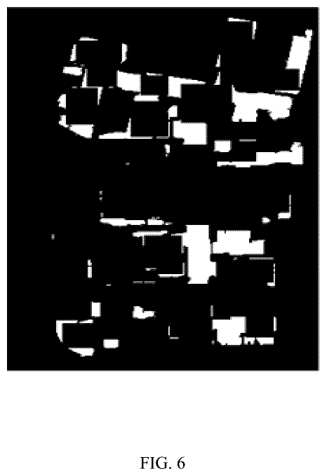

The second area map (see FIG. 6) can be obtained by extracting all of the second areas whose width or length is less than the first preset threshold, or by subtracting the first area map from the target binary map.

When obtaining the second area map according to the target binary map, if the pixel data at the same positions in the target binary map and the first area map are the same, the pixels are set as a black obstacle area. If they are different, they are set as a white working area.

Step S103: Obtain a target area-dividing map of the target area according to the first area map and the second area map.

After the first area map and the second area map are obtained in step S102, the first area map and the second area map need to be further processed, and then the target area-dividing map of the target area can be obtained according to the final processing result.

In one embodiment, step S103 may include: adding all of areas in the second area map that are larger in area than a second preset threshold to the first area map and update the first area map, and updating the second area map; and obtaining the target area-dividing map of the target area according to the updated first area map and the updated second area map.

The second preset threshold is a positive number, which can be set according to actual needs and is not limited here.

If there is an area with an area greater than the second preset threshold in the second area map, the area is removed from the second area map and added to the first area map, and then the first area map and the second area map are updated and saved.

Step S104: Control the mobile robot according to the target area-dividing map.

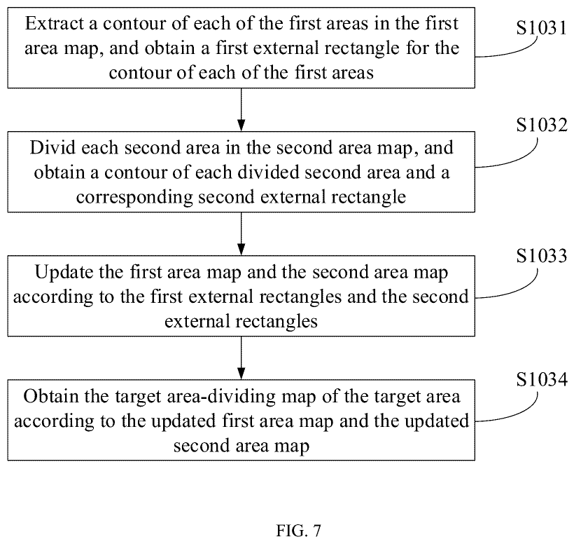

Referring to FIG. 7, in one embodiment, step S103 may include steps S1031 to S1034.

Step S1031: Extract a contour of each of the first areas in the first area map, and obtain a first bounding rectangle for the contour of each of the first areas.

After the first area map is obtained, each area in the first area map is a “large” area. The contour of each large area is extracted, and the number of the contours (i.e., the number of contours is the number of divided areas) is calculated. At the same time, the bounding rectangle of the contour of each large area is calculated and stored on the first area map.

Step S1032: Divid each second area in the second area map, and obtain a contour of each divided second area and a corresponding second bounding rectangle.

After the second area map is obtained, each area in the second area map is a “small” area. In order to determine whether each small area in the second area map is connected with one or more large areas in the first area map, it needs to extract the contours of the small areas in the second area map.

According to the contours of the small areas in the second area map, the bounding rectangle of each small area is obtained, and the bounding rectangle of the contour of each small area is stored in the second area map.

Step S1033: Update the first area map and the second area map according to the first bounding rectangles and the second bounding rectangles.

When updating the first area map and the second area map based on the first bounding rectangles in the first area map and the second bounding rectangles in the second area map, it is sequentially determined whether the bounding rectangle of each small area in the second area map has an intersection with one or more bounding rectangles of the large areas in the first area map. If yes, the number of adjacent points in the contours corresponding to the first bounding rectangles and the second bounding rectangles are calculated and stored. If the second bounding rectangle of the same small area is adjacent to the first bounding rectangles of multiple large areas at the same time, the small area will be merged into the large area with the largest number of adjacent points. Then, the first area map is updated, and the small area is removed from the second area map, until no small areas in the second area map can be merged into the first area map.

Step S1034: Obtain the target area-dividing map of the target area according to the updated first area map and the updated second area map.

The target area-dividing map can be obtained by merging the finally updated first area map and the second area map. The operation path can be replanned according to the target area-dividing map, and the operation efficiency of the mobile robot can be improved when the operation is performed based on the path.

In one embodiment, the method may further include step S105 after step S104.

Step S105: Differentiate obstacle areas and working areas of the target area-dividing map by color, number or text labels.

When differentiate the working areas in the target area-dividing map, different colors can be used to mark each area. This allows for the planning of a more accurate path, which increases efficiency when performing tasks and can meet the diverse needs of different users.

In one embodiment, the method may further include the following step after step S105: controlling the mobile robot to bypass the obstacle areas and operate in the working areas according to the target area-dividing map.

By using the method described above to obtain the target area-dividing map, the target area is divided into different areas, which not only reduces the complexity of the map but also increases efficiency when performing tasks based on the work path planned from the target area-dividing map. For example, after a cleaning robot completes its initial cleaning, it can obtain an initial binary map of the entire house. By preprocessing, a target binary map of the whole house can be generated. To improve the efficiency of subsequent cleanings, a target area-dividing map of the entire house can be obtained based on the target binary map, distinguishing each bedroom, living room, and kitchen. This allows the cleaning robot to clean each area one by one, thereby improving cleaning efficiency.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

FIG. 9 is a schematic block diagram of a device for area dividing in a map for a mobile robot. In one embodiment, the device may include a first acquisition unit 901, a second acquisition unit 902, a third acquisition unit 903, and a control unit 904. The first acquisition unit 901 is to obtain a target binary map of a target area. The second acquisition unit 902 is to obtain a first area map and a second area map according to the target binary map. The third acquisition unit 903 is to obtain a target area-dividing map of the target area according to the first area map and the second area map. The control unit 904 is to control the mobile robot according to the target area-dividing map.

In one embodiment, the first acquisition unit 901 is to: obtain an initial binary map of the target area, wherein the initial binary map is generated by the mobile robot in a mapping process for the target area; and preprocess the initial binary map to obtain the target binary map, wherein the preprocessing is denoising.

In one embodiment, the second acquisition unit 902 is to: extract all of first areas in the target binary map whose lengths are greater than a first preset threshold to obtain the first area map; and extract all of second areas in the target binary map whose lengths are less than the first preset threshold to obtain the second area map.

In one embodiment, the second acquisition unit 903 is to: add all of areas in the second area map that are larger in area than a second preset threshold to the first area map and update the first area map, and updating the second area map; and obtain the target area-dividing map of the target area according to the updated first area map and the updated second area map.

In one embodiment, the second acquisition unit 903 is to: extract a contour of each of the first areas in the first area map, and obtaining a first bounding rectangle for the contour of each of the first areas; divide each second area in the second area map, and obtaining a contour of each divided second area and a corresponding second bounding rectangle; update the first area map and the second area map according to the first bounding rectangles and the second bounding rectangles; and obtain the target area-dividing map of the target area according to the updated first area map and the updated second area map.

In one embodiment, the device further includes a differentiation unit 105 that is to differentiate obstacle areas and working areas of the target area-dividing map by color, number or text labels.

In one embodiment, the control unit 104 is further to control the mobile robot to bypass the obstacle areas and operate in the working areas according to the target area-dividing map.

Each unit in the device discussed above may be a software program module, or may be implemented by different logic circuits integrated in a processor or independent physical components connected to a processor, or may be implemented by multiple distributed processors.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for area dividing in a map for a mobile robot, the method comprising:
obtaining a target binary map of a target area;
obtaining a first area map and a second area map according to the target binary map;
obtaining a target area-dividing map of the target area according to the first area map and the second area map; and
controlling the mobile robot according to the target area-dividing map.

2. The method of claim 1, wherein obtaining the target binary map of the target area comprises:
obtaining an initial binary map of the target area, wherein the initial binary map is generated by the mobile robot in a mapping process for the target area; and
preprocessing the initial binary map to obtain the target binary map, wherein the preprocessing is denoising.

3. The method of claim 1, wherein obtaining the first area map and the second area map according to the target binary map comprises:
extracting all of first areas in the target binary map whose lengths are greater than a first preset threshold to obtain the first area map; and
extracting all of second areas in the target binary map whose lengths are less than the first preset threshold to obtain the second area map.

4. The method of claim 1, wherein obtaining the target area-dividing map of the target area according to the first area map and the second area map comprises:
adding all of areas in the second area map that are larger in area than a second preset threshold to the first area map and update the first area map, and updating the second area map; and
obtaining the target area-dividing map of the target area according to the updated first area map and the updated second area map.

5. The method of claim 4, wherein obtaining the target area-dividing map of the target area according to the first area map and the second area map comprises:
extracting a contour of each of the first areas in the first area map, and obtaining a first bounding rectangle for the contour of each of the first areas;
dividing each second area in the second area map, and obtaining a contour of each divided second area and a corresponding second bounding rectangle;
updating the first area map and the second area map according to the first bounding rectangles and the second bounding rectangles; and
obtaining the target area-dividing map of the target area according to the updated first area map and the updated second area map.

6. The method of claim 1, further comprising, after obtaining the target area-dividing map of the target area according to the first area map and the second area map,
differentiating obstacle areas and working areas of the target area-dividing map by color, number or text labels.

7. The method of claim 6, wherein controlling the mobile robot according to the target area-dividing map comprises: controlling the mobile robot to bypass the obstacle areas and operate in the working areas according to the target area-dividing map.

8. A mobile robot comprising:
one or more processors; and
a memory coupled to the one or more processors, the memory storing programs that, when executed by the one or more processors, cause performance of operations comprising:
obtaining a target binary map of a target area;
obtaining a first area map and a second area map according to the target binary map;
obtaining a target area-dividing map of the target area according to the first area map and the second area map; and
controlling the mobile robot according to the target area-dividing map.

9. The mobile robot of claim 8, wherein obtaining the target binary map of the target area comprises:
obtaining an initial binary map of the target area, wherein the initial binary map is generated by the mobile robot in a mapping process for the target area; and
preprocessing the initial binary map to obtain the target binary map, wherein the preprocessing is denoising.

10. The mobile robot of claim 8, wherein obtaining the first area map and the second area map according to the target binary map comprises:
extracting all of first areas in the target binary map whose lengths are greater than a first preset threshold to obtain the first area map; and
extracting all of second areas in the target binary map whose lengths are less than the first preset threshold to obtain the second area map.

11. The mobile robot of claim 8, wherein obtaining the target area-dividing map of the target area according to the first area map and the second area map comprises:
adding all of areas in the second area map that are larger in area than a second preset threshold to the first area map and update the first area map, and updating the second area map; and
obtaining the target area-dividing map of the target area according to the updated first area map and the updated second area map.

12. The mobile robot of claim 11, wherein obtaining the target area-dividing map of the target area according to the first area map and the second area map comprises:
extracting a contour of each of the first areas in the first area map, and obtaining a first bounding rectangle for the contour of each of the first areas;
dividing each second area in the second area map, and obtaining a contour of each divided second area and a corresponding second bounding rectangle;
updating the first area map and the second area map according to the first bounding rectangles and the second bounding rectangles; and
obtaining the target area-dividing map of the target area according to the updated first area map and the updated second area map.

13. The mobile robot of claim 8, where the operations further comprise, after obtaining the target area-dividing map of the target area according to the first area map and the second area map,
differentiating obstacle areas and working areas of the target area-dividing map by color, number or text labels.

14. The mobile robot of claim 13, wherein controlling the mobile robot according to the target area-dividing map comprises: controlling the mobile robot to bypass the obstacle areas and operate in the working areas according to the target area-dividing map.

15. A non-transitory computer-readable storage medium storing instructions that, when executed by at least one processor of a mobile robot, cause the at least one processor to perform a method, the method comprising:
obtaining a target binary map of a target area;
obtaining a first area map and a second area map according to the target binary map;
obtaining a target area-dividing map of the target area according to the first area map and the second area map; and
controlling the mobile robot according to the target area-dividing map.

16. The non-transitory computer-readable storage medium of claim 15, wherein obtaining the target binary map of the target area comprises:
obtaining an initial binary map of the target area, wherein the initial binary map is generated by the mobile robot in a mapping process for the target area; and
preprocessing the initial binary map to obtain the target binary map, wherein the preprocessing is denoising.

17. The non-transitory computer-readable storage medium of claim 15, wherein obtaining the first area map and the second area map according to the target binary map comprises:
extracting all of first areas in the target binary map whose lengths are greater than a first preset threshold to obtain the first area map; and
extracting all of second areas in the target binary map whose lengths are less than the first preset threshold to obtain the second area map.

18. The non-transitory computer-readable storage medium of claim 15, wherein obtaining the target area-dividing map of the target area according to the first area map and the second area map comprises:
adding all of areas in the second area map that are larger in area than a second preset threshold to the first area map and update the first area map, and updating the second area map; and
obtaining the target area-dividing map of the target area according to the updated first area map and the updated second area map.

19. The non-transitory computer-readable storage medium of claim 18, wherein obtaining the target area-dividing map of the target area according to the first area map and the second area map comprises:
extracting a contour of each of the first areas in the first area map, and obtaining a first bounding rectangle for the contour of each of the first areas;
dividing each second area in the second area map, and obtaining a contour of each divided second area and a corresponding second bounding rectangle;
updating the first area map and the second area map according to the first bounding rectangles and the second bounding rectangles; and
obtaining the target area-dividing map of the target area according to the updated first area map and the updated second area map.

20. The non-transitory computer-readable storage medium of claim 15, wherein the method further comprises, after obtaining the target area-dividing map of the target area according to the first area map and the second area map, differentiating obstacle areas and working areas of the target area-dividing map by color, number or text labels.
